(19) United States
(12) Patent Application Publication
(10) Pub. No.: US 2023/0352234 A1
(43) Pub. Date: Nov. 2, 2023

(54) COIL COMPONENT AND MANUFACTURING METHOD THEREFOR

(71) Applicant: TDK Corporation, Tokyo (JP)

(72) Inventors: Yuuichi KAWAGUCHI, Tokyo (JP); Mitsuo NATORI, Tokyo (JP); Azuma SATOH, Tokyo (JP); Naoaki FUJII, Tokyo (JP); Tomonaga NISHIKAWA, Tokyo (JP)

(21) Appl. No.: 18/245,408

(22) PCT Filed: Sep. 7, 2021
(86) PCT No.: PCT/JP2021/032849

§ 371 Date: Mar. 15, 2023

(30) Foreign Application Priority Data
Sep. 28, 2020 (JP) 2020-162540

(51) Int. Cl. H01F 27/32; H01F 27/02; H01F 27/28; H01F 27/255; H01F 41/00; H01F 41/12

(52) U.S. Cl. CPC H01F 27/327; H01F 27/022; H01F 27/2852; H01F 27/255; H01F 27/323; H01F 41/005; H01F 41/122; H01F 41/127

(57) ABSTRACT

A coil component includes: a magnetic element body made of resin containing conductive magnetic powder; a coil part 20 obtained by alternately stacking a plurality of conductor layers and a plurality of interlayer insulating layers, the plurality of conductor layers respectively including coil conductor patterns embedded in the magnetic element body and electrode patterns exposed from the magnetic element body; external terminals provided respectively on the electrode patterns and electrode patterns; and a protective insulating layer covering the magnetic element body in such a manner as to expose the external terminals therethrough. The magnetic element body is thus covered with the protective insulating layer, so that it is possible to prevent adhesion of plating to an unnecessary portion and exposure of the coil conductor patterns even when the surfaces of the external terminals are subjected to electrolytic plating.

### TECHNICAL FIELD

The present invention relates to a coil component and a manufacturing method therefor and, more particularly, to a coil component having a structure in which a coil layer obtained by alternately stacking a plurality of conductor layers and a plurality of interlayer insulating layers is embedded in a magnetic element body and a manufacturing method for such a coil component.

### BACKGROUND ART

Patent Document 1 describes a coil component having a structure in which a coil layer obtained by alternately stacking a plurality of conductor layers and a plurality of interlayer insulating layers is embedded in a magnetic element body. The magnetic element body used in the coil component described in Patent Document 1 is made of resin containing magnetic powder such as ferrite powder or magnetic metal powder.

### CITATION LIST

### Patent Document

[Patent Document 1] JP 2018-190828A

### SUMMARY OF THE INVENTION

### Problem to be Solved by the Invention

However, when the magnetic powder used for the magnetic element body has conductivity, plating is undesirably formed also on the surface of the magnetic element body upon formation of an external terminal by electrolytic plating. To solve this, the surface of the magnetic element body may be subjected to soft etching before application of the electrolytic plating; however, excessive etching of the magnetic element body may expose a coil conductor pattern embedded in the magnetic element body.

It is therefore an object of the present invention to prevent adhesion of plating to an unnecessary portion and exposure of a coil conductor pattern in a coil component having a structure in which a coil layer obtained by alternately stacking a plurality of conductor layers and a plurality of interlayer insulating layers is embedded in a magnetic element body.

### Means for Solving the Problem

A coil component according to the present invention includes: a magnetic element body made of resin containing conductive magnetic powder; a coil part obtained by alternately stacking a plurality of conductor layers and a plurality of interlayer insulating layers, the plurality of conductor layers including a coil conductor pattern embedded in the magnetic element body and an electrode pattern exposed from the magnetic element body; an external terminal provided on the electrode pattern; and a protective insulating layer covering the magnetic element body in such a manner as to expose the external terminal therethrough.

According to the present invention, the magnetic element body is covered with the protective insulating layer, so that it is possible to prevent adhesion of plating to an unnecessary portion and exposure of the coil conductor pattern even when the surface of the external terminal is subjected to electrolytic plating.

In the present invention, the protective insulating layer may cover the entire surface of the magnetic element body. This can prevent adhesion of plating to an unnecessary portion and exposure of the coil conductor pattern more reliably.

In the present invention, the surface of the magnetic element body may have unevenness due to the presence of the protruding or dropped conductive magnetic powder, and the protective insulating layer may cover the surface of the magnetic element body so as to fill in the unevenness. This can enhance adhesion between the magnetic element body and the protective insulating layer.

In the present invention, the surface of the external terminal and a part of the surface of the protective insulating layer in the vicinity around the external terminal may be flush with each other. This can prevent unnecessary spreading of a solder at the time of mounting.

In the present invention, the external terminal may be made of conductive paste. This prevents a plating film from adhering to the surface of the magnetic element body during formation of the external terminal.

In the present invention, the external terminal may be exposed to one surface of the coil component that is perpendicular to the stacking direction of the conductor layers and interlayer insulating layers and formed over the entire width of the one surface in the stacking direction. This enhances mounting strength when the coil component is mounted on a circuit board using a solder or the like.

A manufacturing method for the coil component according to the present invention includes: the steps of alternately stacking a plurality of conductor layers, which include a coil conductor pattern and an electrode pattern, and a plurality of interlayer insulating layers to form a coil layer; embedding the coil layer in a magnetic element body made of resin containing conductive magnetic powder; singulating or grinding the magnetic element body to expose the electrode pattern; forming an external terminal on the electrode pattern by application; covering the surfaces of the magnetic element body and external terminal with a protective insulating layer; and grinding the protective insulating layer to expose the external terminal.

According to the present invention, the terminal electrode is formed by application, so that, unlike the case where the external terminal is formed by electrolytic plating, it is not necessary to perform soft etching for the magnetic element body.

### Advantageous Effects of the Invention

As described above, according to the present invention, in a coil component having a structure in which a coil layer obtained by alternately stacking a plurality of conductor layers and a plurality of interlayer insulating layers is embedded in a magnetic element body, it is possible to prevent adhesion of plating to an unnecessary portion and exposure of a coil conductor pattern.

### BRIEF DESCRIPTION OF THE DRAWINGS

FIG. 1 is a perspective view schematically illustrating the outer appearance of a coil component 1 according to a preferred embodiment of the present invention.

FIG. 2 is an xy cross-sectional view of the coil component 1.

FIG. 3 is a cross-sectional view of the coil component 1 taken along the line A-A in FIG. 2.

FIG. 4 is a process view for explaining the manufacturing process for the coil component 1.

FIG. 5 is a process view for explaining the manufacturing process for the coil component 1.

FIG. 6 is a process view for explaining the manufacturing process for the coil component 1.

FIG. 7 is a schematic perspective view illustrating the outer appearance of a coil component 2 according to a modification.

### MODE FOR CARRYING OUT THE INVENTION

Hereinafter, preferred embodiments of the present invention will be described in detail with reference to the accompanying drawings.

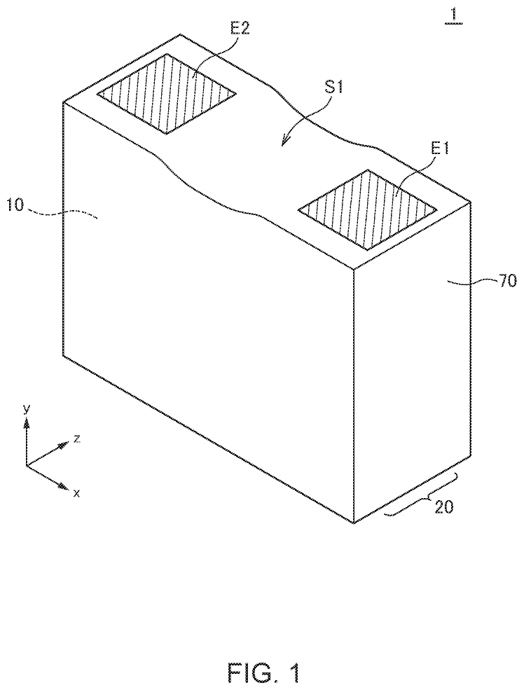

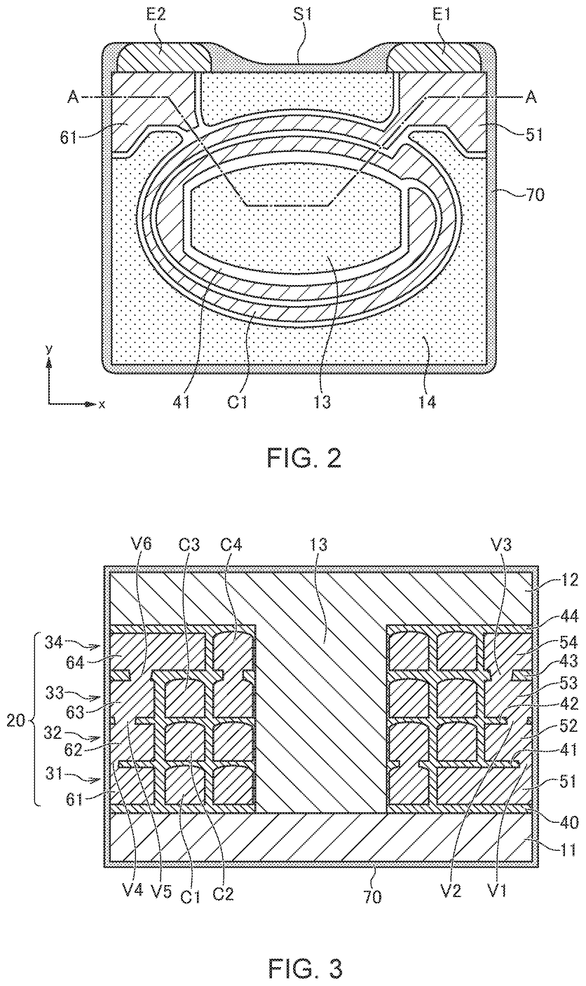

FIG. 1 is a perspective view schematically illustrating the outer appearance of a coil component 1 according to a preferred embodiment of the present invention. FIG. 2 is an xy cross-sectional view of the coil component 1, and FIG. 3 is a cross-sectional view of the coil component 1 taken along the line A-A in FIG. 2.

The coil component 1 according to the present embodiment is a surface-mount type chip component suitably used as an inductor for a power supply circuit and has, as illustrated in FIGS. 1 to 3, a magnetic element body 10 including magnetic layers 11 to 14, a coil part 20 embedded in the magnetic element body 10, a protective insulating layer 70 covering the surface of the magnetic element body 10, and external terminals E1 and E2 exposed from the protective insulating layer 70. Although the configuration of the coil part 20 will be described later, in the present embodiment, four conductor layers each having a coil conductor pattern are stacked to form one coil. One end of the coil is connected to the external terminal E1, and the other end thereof is connected to the external terminal E2.

The magnetic element body 10 is a composite member made of resin containing conductive magnetic powder such as ferrite powder or magnetic metal powder and constitutes a magnetic path for magnetic flux generated by making current flow in a coil. When magnetic metal powder is used as the magnetic powder, a permalloy-based material is preferably used. Further, the resin is preferably epoxy resin of liquid or powder.

Unlike common multilayer coil component, the coil component 1 according to the present embodiment is vertically mounted such that the z-direction which is the stacking direction is parallel to a circuit board. Specifically, a surface S1 constituting the xz plane is used as a mounting surface. From the surface S1, the external terminals E1 and E2 are exposed. The surfaces other than the surface S1 are entirely covered with the protective insulating layer 70. The external terminals E1 and E2 are each made of conductive paste such as nano-silver paste or nano-copper paste. The surface of each of the external terminals E1 and E2 that is exposed from the protective insulating layer 70 is covered with a laminated film of nickel (Ni) and tin (Sn) for maintaining wettability.

The protective insulating layer 70 plays a role of protecting the magnetic element body 10 and preventing drop of the conductive magnetic powder contained in the magnetic element body 10. The surface of the magnetic element body 10 has unevenness due to the presence of the protruding or dropped conductive magnetic powder, and the protective insulating layer 70 covers the surface of the magnetic element body 10 so as to fill in the unevenness, thereby enhancing adhesion between the magnetic element body 10 and the protective insulating layer 70. While the protective insulating layer 70 preferably covers the entire surface of the magnetic element body 10, the magnetic element body 10 may be partially exposed.

As illustrated in FIG. 2, the surface S1 as the mounting surface has a recess between the external terminals E1 and E2. This is due to a manufacturing process to be described later. The presence of such a recess increases the creepage distance between the external terminals E1 and E2, making it less likely to cause a short-circuit failure. Further, the main part of the external terminal E1 (E2), i.e., a part thereof that is made of conductive paste does not protrude from the protective insulating layer 70. It follows that the surface of the external terminal E1 (E2) and a part of the surface of the protective insulating layer 70 in the vicinity around the external terminal E1 (E2) are flush with each other. This can prevent unnecessary spreading of a solder at the time of mounting. The laminated film of nickel (Ni) and tin (Sn) formed on the surface of each of the external terminals E1 and E2 may slightly protrude from the surface of the protective insulating layer 70.

As illustrated in FIG. 3, the coil part 20 has a configuration in which interlayer insulating layers 40 to 44 and conductor layers 31 to 34 are alternately stacked. The conductor layers 31 to 34 are connected to one another through holes formed in the interlayer insulating layers 41 to 43 to constitute a coil. The coil part 20 is covered with the magnetic layer 11 at one side thereof in the axial direction and covered with the magnetic layer 12 at the other side thereof in the axial direction. The inner diameter area of the coil part 20 is filled with the magnetic layer 13. Further, as illustrated in FIG. 2, the outside area of the coil part 20 is covered with the magnetic layer 14. The magnetic layers 11 to 14 may be made of the same composite material or may be made of composite materials partly different from each other.

The interlayer insulating layers 40 to 44 are made of, e.g., resin, and at least the interlayer insulating layers 41 to 43 are made of a nonmagnetic material. The interlayer insulating layer 40 positioned in the lowermost layer and the interlayer insulating layer 44 positioned in the uppermost layer may be made of a magnetic material.

The conductor layer 31 is the first conductor layer formed on the upper surface of the magnetic layer 11 through the interlayer insulating layer 40. The conductor layer 31 has a coil conductor pattern C1 spirally wound in two turns and two electrode patterns 51 and 61. The coil conductor pattern C1 is embedded in the magnetic element body 10, and the electrode patterns 51 and 61 are exposed from the magnetic element body 10. The electrode pattern 51 is connected to the outer peripheral end of the coil conductor pattern C1, while the electrode pattern 61 is provided independently of the coil conductor pattern C1.

The conductor layer 32 is the second conductor layer formed on the upper surface of the conductor layer 31 through the interlayer insulating layer 41. The conductor layer 32 has a coil conductor pattern C2 spirally wound in two turns and two electrode patterns 52 and 62. The coil conductor pattern C2 is embedded in the magnetic element body 10, and the electrode patterns 52 and 62 are exposed from the magnetic element body 10. The inner peripheral end of the coil conductor pattern C2 is connected to the inner peripheral end of the coil conductor pattern C1 through a via formed in the interlayer insulating layer 41. The electrode patterns 52 and 62 are both provided independently of the coil conductor pattern C2.

The conductor layer 33 is the third conductor layer formed on the upper surface of the conductor layer 32 through the interlayer insulating layer 42. The conductor layer 33 has a coil conductor pattern C3 spirally wound in two turns and two electrode patterns 53 and 63. The coil conductor pattern C3 is embedded in the magnetic element body 10, and the electrode patterns 53 and 63 are exposed from the magnetic element body 10. The outer peripheral end of the coil conductor pattern C3 is connected to the outer peripheral end of the coil conductor pattern C2 through a via formed in the interlayer insulating layer 42. The electrode patterns 53 and 63 are both provided independently of the coil conductor pattern C3.

The conductor layer 34 is the fourth conductor layer formed on the upper surface of the conductor layer 33 through the interlayer insulating layer 43. The conductor layer 34 has a coil conductor pattern C4 spirally wound in two turns and two electrode patterns 54 and 64. The coil conductor pattern C4 is embedded in the magnetic element body 10, and the electrode patterns 54 and 64 are exposed from the magnetic element body 10. The electrode pattern 64 is connected to the outer peripheral end of the coil conductor pattern C4, while the electrode patterns 54 is provided independently of the coil conductor pattern C4. The inner peripheral end of the coil conductor pattern C4 is connected to the inner peripheral end of the coil conductor pattern C3 through a via formed in the interlayer insulating layer 43.

With the configuration described above, a coil of eight turns is formed by the coil conductor patterns C1 to C4, and one end of the thus formed coil is connected to the external terminal E1, and the other end thereof is connected to the external terminal E2.

The electrode patterns 51 to 54 are connected to one another through via conductors V1 to V3 penetrating respectively the interlayer insulating layers 41 to 43. Similarly, the electrode patterns 61 to 64 are connected to one another through via conductors V4 to V6 penetrating respectively the interlayer insulating layers 41 to 43. As viewed in the stacking direction, the via conductors V1 to V3 are formed at mutually different positions, and the via conductors V4 to V6 are also formed at mutually different positions. In the cross section illustrated in FIG. 3, the electrode patterns 51 to 54 and 61 to 64 are covered with the protective insulating layer 70.

As described above, in the coil component 1 according to the present embodiment, the entire surface of the magnetic element body 10 is covered with the protective insulating layer 70, so that it is possible to prevent dropping of the conductive magnetic powder contained in the magnetic element body 10. In addition, the external terminals E1 and E2 are exposed only to the surface S1 as the mounting surface, so that it is possible to prevent unnecessary spreading of a solder at the time of mounting. Further, since the surface S1 has a recess between the external terminals E1 and E2, the creepage distance between the external terminals E1 and E2 increases, thus making it possible to prevent a short-circuit failure.

The following describes a manufacturing method for the coil component 1 according to the present embodiment.

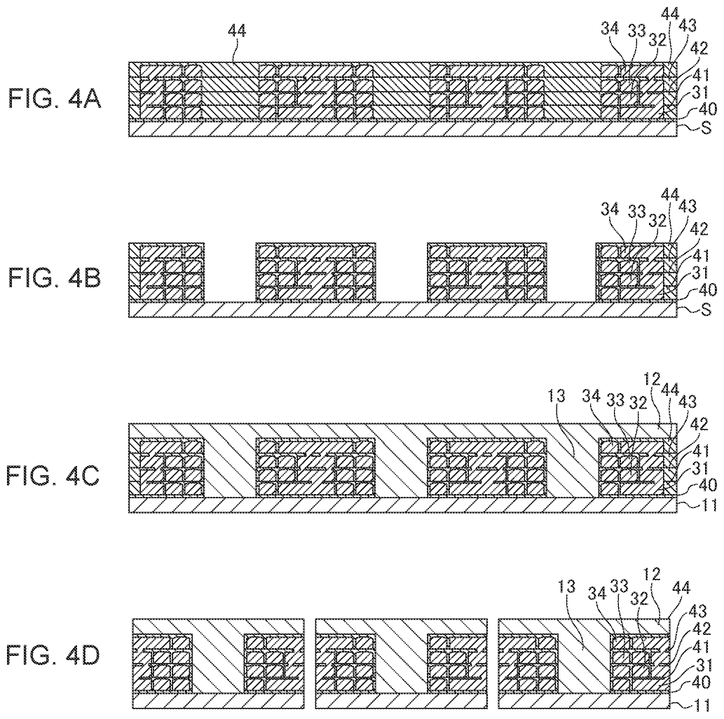

FIGS. 4 to 6 are process views for explaining the manufacturing process for the coil component 1 according to the present embodiment.

As illustrated in FIG. 4A, a support substrate S having a predetermined strength is prepared, and the interlayer insulating layers 40 to 44 and the conductor layers 31 to 34 are alternately formed. The interlayer insulating layers 40 to 44 can be formed by applying a resin material according to a spin coating method. The conductor layers 31 to 34 can be formed by forming an underlying metal film using a thin-film process such as a spattering method and then by growing the underlying metal film to a desired thickness using an electrolytic plating method.

Then, as illustrated in FIG. 4B, parts of the interlayer insulating layers 40 to 44 and conductor layers 31 to 34 that are positioned in the inner diameter area surrounded by the coil conductor patterns C1 to C4 and in the outside area positioned outside the coil conductor patterns C1 to C4 are removed to form a space. Then, as illustrated in FIG. 4C, the space thus formed is filled with a resin composite material containing conductive magnetic powder to thereby form the magnetic element body 10. Then, as illustrated in FIG. 4D, singulation is performed by dicing. As a result, the electrode patterns 51 to 54 and 61 to 64 are partially exposed from the dicing surface. The process of exposing the electrode patterns 51 to 54 and 61 to 64 may be performed by grinding the surface of the magnetic element body 10 after singulation.

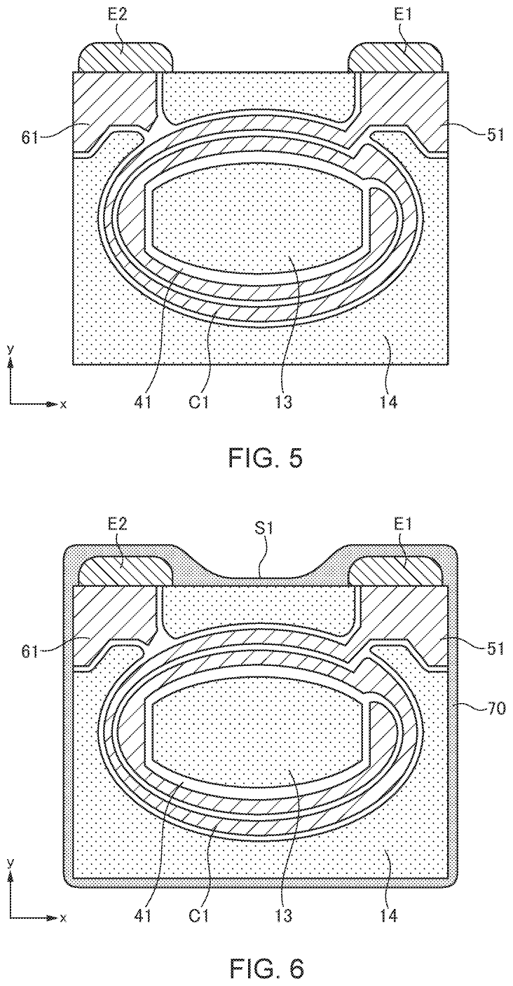

Then, as illustrated in FIG. 5, conductive paste is applied to the electrode patterns 51 to 54 and 61 to 64 to form the external terminals E1 and E2. Application of the conductive paste eliminates the need to previously perform soft etching for the magnetic element body 10 unlike the case where the external terminals E1 and E2 are formed by electrolytic plating. Then, as illustrated in FIG. 6, the entire surface of the magnetic element body 10 is covered with the protective insulating layer 70. The protective insulating layer 70 can be formed by a dip coating method, a spray coating method, or an electrostatic spraying method. With any of the above methods, the unevenness of the surface of the magnetic element body 10 is filled with the protective insulating layer 70, with the result that magnetic element body 10 and protective insulating layer 70 firmly adhere to each other. In this stage, the external terminals E1 and E2 are also covered with the protective insulating layer 70.

Then, after the surface S1 as the mounting surface is ground to expose the external terminals E1 and E2, electrolytic plating is performed to form a laminated film of nickel (Ni) and tin (Sn) in the surfaces of the external terminals E1 and E2, whereby the coil component 1 according to the present embodiment is completed.

As described above, in the present embodiment, the external terminals E1 and E2 are formed by application, thus eliminating the need to perform soft etching for the magnetic element body 10. Further, the surface of the magnetic element body 10 is covered with the protective insulating layer 70, so that plating does not adhere to an unnecessary portion during a process of plating the external terminals E1 and E2.

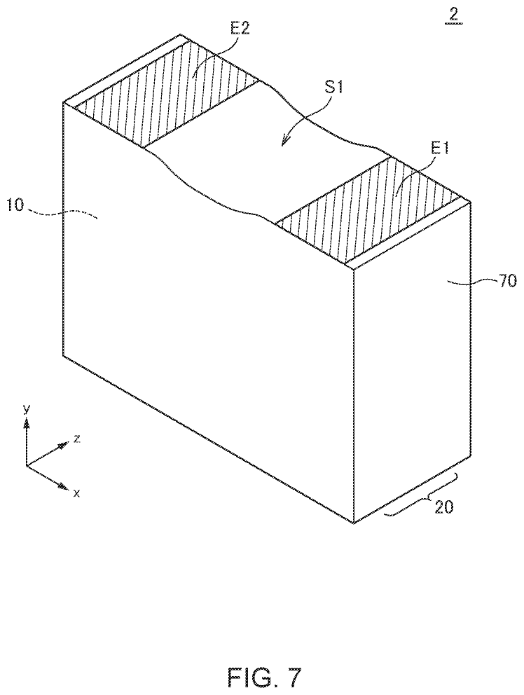

FIG. 7 is a schematic perspective view illustrating the outer appearance of a coil component 2 according to a modification.

The coil component 2 illustrated in FIG. 7 differs from the coil component 1 according to the present embodiment in that the external terminals E1 and E2 are formed over the entire width of the surface S1 in the z-direction. As exemplified by the coil component 2 according to the modification, forming the external terminals E1 and E2 over the entire width of the surface S1 in the z-direction allows increase in mounting strength when the coil component 2 is mounted on a circuit board using a solder.

While the preferred embodiment of the present disclosure has been described, the present disclosure is not limited to the above embodiment, and various modifications may be made within the scope of the present disclosure, and all such modifications are included in the present disclosure.

For example, although the coil part 20 includes the four conductor layers 31 to 34 in the above embodiment, the number of the conductor layers is not limited to this in the present invention. Further, the number of turns of the coil conductor pattern formed in each conductor layer is not particularly limited to a specific number.

### REFERENCE SIGNS LIST

1, 2 coil component
10 magnetic element body
11-14 magnetic layer
20 coil part
31-34 conductor layer
40-44 interlayer insulating layer
51-54, 61-64 electrode pattern
70 protective insulating layer
C1-C4 coil conductor pattern
E1, E2 external terminal
S support substrate
S1 surface of coil component
V1-V6 via conductor

1. A coil component comprising:
a magnetic element body made of resin containing conductive magnetic powder;
a coil part obtained by alternately stacking a plurality of conductor layers and a plurality of interlayer insulating layers, the plurality of conductor layers including a coil conductor pattern embedded in the magnetic element body and an electrode pattern exposed from the magnetic element body;
an external terminal provided on the electrode pattern; and
a protective insulating layer covering the magnetic element body in such a manner as to expose the external terminal therethrough.

2. The coil component as claimed in claim 1, wherein the protective insulating layer covers an entire surface of the magnetic element body.

3. The coil component as claimed in claim 1,
wherein a surface of the magnetic element body has unevenness due to a presence of a protruding or dropped conductive magnetic powder, and
wherein the protective insulating layer covers the surface of the magnetic element body so as to fill in the unevenness.

4. The coil component as claimed in claim 1, wherein a surface of the external terminal and a part of a surface of the protective insulating layer in a vicinity around the external terminal are flush with each other.

5. The coil component as claimed in claim 1, wherein the external terminal is made of conductive paste.

6. The coil component as claimed in claim 1, wherein the external terminal is exposed to one surface of the coil component that is perpendicular to a stacking direction of the conductor layers and interlayer insulating layers and formed over an entire width of the one surface in the stacking direction.

7. A method for manufacturing a coil component, the method comprising:
a step of alternately stacking a plurality of conductor layers, which include a coil conductor pattern and an electrode pattern, and a plurality of interlayer insulating layers to form a coil layer;
a step of embedding the coil layer in a magnetic element body made of resin containing conductive magnetic powder;
a step of singulating or grinding the magnetic element body to expose the electrode pattern;
a step of forming an external terminal on the electrode pattern by application;
a step of covering a surfaces of the magnetic element body and external terminal with a protective insulating layer; and
a step of grinding the protective insulating layer to expose the external terminal.

8. The coil component as claimed in claim 2,
wherein a surface of the magnetic element body has unevenness due to a presence of a protruding or dropped conductive magnetic powder, and
wherein the protective insulating layer covers the surface of the magnetic element body so as to fill in the unevenness.
